(19) United States
(12) Patent Application Publication
(10) Pub. No.: US 2026/0132059 A1
(43) Pub. Date: May 14, 2026

(54) HYDROGEN BONDING STABILIZED POLYARYL ORGANIC SOLVENT NANOFILTRATION MEMBRANE

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA)

(73) Assignee: KING FAHD UNIVERSITY OF PETROLEUM AND MINERALS, Dhahran (SA)

(21) Appl. No.: 18/944,758

(22) Filed: Nov. 12, 2024

(51) Int. Cl. C02F 1/44; C02F 101/30

(52) U.S. Cl. CPC C02F 1/442; C02F 2101/30

(57) ABSTRACT

A filtration membrane that includes a nonwoven textile, the nonwoven textile including polyethylene terephthalate. The filtration membrane includes a first layer of carboxylate-containing polymer disposed on the nonwoven textile. The filtration membrane further includes a second layer, which includes polypyrrole disposed on the first layer. The polypyrrole is connected to the first layer by hydrogen bonds between the amine groups present in the polypyrrole and the carboxylate groups present in the carboxylate-containing polymer. The membrane is effective in removing organic pollutant from water.

### STATEMENT OF PRIOR DISCLOSURE BY AN INVENTOR

Aspects of the present disclosure are described in Umair Baig and Abdul Waheed; “Development of hydrogen bonding stabilized conjugated carbonaceous polyaryl organic solvent nanofiltration membranes for molecular sieving”; Green Chemistry, 2024, 26, 7156-7175, which is incorporated herein by reference in its entirety.

### STATEMENT OF ACKNOWLEDGEMENT

Support of King Fahd University of Petroleum and Minerals (KFUPM), and the Interdisciplinary Research Center for Membranes and Water Security (IRC-M&WS) through project INMW2313 is gratefully acknowledged.

### BACKGROUND

### Technical Field

The present disclosure is directed towards a hydrogen bonding-stabilized polyaryl organic nanofiltration membrane.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Organic solvent nanofiltration (OSN) is an advanced technology that separates molecules and efficiently recovers valuable organic solvents. OSN membranes mitigate energy consumption relative to conventional methods such as distillation and evaporation, which are known for their high energy demands. These conventional techniques significantly contribute to global energy consumption within the chemical industry. OSN membranes are typically manufactured using methodologies such as interfacial polymerization, which demonstrate substantial potential for solvent recovery.

However, interfacial polymerization (IP), a prevalent technique for OSN membrane fabrication, utilizes hazardous solvents like n-hexane, presenting safety and environmental concerns. Surfactants are sometimes utilized to aid in monomer transfer and polymer network formation at the interface, mitigating these issues. The IP process generates HCl, necessitating precise control and neutralization to prevent adverse impacts on membrane formation. Alternative approaches encompass ceramic and organic-inorganic hybrid membranes, offering robust chemical resistance and stability, albeit requiring considerable energy for production. Innovations such as employing renewable nanocellulose fibers or plasma grafting of polyethylene glycol (PEG) onto polyimide supports demonstrate potential for achieving greener, more efficient membrane manufacturing.

Hence, it is one object of the present disclosure to provide a method of fabricating membrane that may circumvent the above-stated drawbacks, such as higher energy consumption, higher chemical inputs, and lesser stability of current methods.

### SUMMARY

The present disclosure is directed to a filtration membrane. In some embodiments, the filtration membrane includes a nonwoven textile including polyethylene terephthalate. In some embodiments, the filtration membrane includes a first layer including a carboxylate-containing polymer disposed on the nonwoven textile. In some embodiments, the filtration membrane includes a second layer including polypyrrole disposed on the first layer. In some embodiments, the polypyrrole is connected to the first layer by hydrogen bonds between amine groups present in the polypyrrole and carboxylate groups present in the carboxylate-containing polymer.

In some embodiments, the polypyrrole is present as unbranched chains.

In some embodiments, the second layer comprises granules of polypyrrole.

In some embodiments, the granules of polypyrrole have a mean particle size of 100 to 1000 nm.

In some embodiments, the carboxylate-containing polymer is hydrolyzed polyacrylonitrile.

In some embodiments, the hydrolyzed polyacrylonitrile has a mean molecular weight of 50,000 to 500,000 g/mol.

In some embodiments, the filtration membrane has a water contact angle of 10 to 30°.

In some embodiments, the filtration membrane has an average surface roughness Rₐ of 10 to 37.5 nm and a mean square surface roughness R_{q} of 20 to 50 nm.

In some embodiments, the filtration membrane has a water flux of 75 to 150 Lm⁻²h⁻¹ at a transmembrane pressure of 20 bar.

In some embodiments, the filtration membrane has a rejection rate for organic pollutants having a negative charge and a molecular weight of at least 350 g/mol of greater than 97.5%.

In some embodiments, the filtration membrane is substantially free of graphene oxide.

In some embodiments, the filtration membrane is substantially free of polyaniline.

The present disclosure is also directed to a method of forming the filtration membrane. In some embodiments, the method includes depositing a polymer including a functional group capable of being hydrolyzed to a carboxylate group onto the nonwoven textile including polyethylene terephthalate. In some embodiments, the method further includes drying the first solvent to form a coated precursor, treating the coated precursor with an aqueous base to hydrolyze the polymer including a functional group capable of being hydrolyzed to a carboxylate group to the carboxylate-containing polymer to form a coated textile, depositing pyrrole onto the coated textile to form a pyrrole-comprising precursor, and polymerizing the pyrrole in the pyrrole-comprising precursor to form the filtration membrane.

In some embodiments, the polymer comprising a functional group capable of being hydrolyzed to a carboxylate group is polyacrylonitrile, having a molecular weight of 50,000 to 500,000 g/mol.

In some embodiments, the method of polymerizing the pyrrole in the pyrrole-comprising precursor is performed by treating the pyrrole-comprising precursor with a polymerization solution comprising iron chloride.

In some embodiments, the method further comprises treating the coated textile with a neutralization solution comprising an acid prior to depositing pyrrole onto the coated textile.

In some embodiments, a method of removing an organic pollutant from water comprises contacting water containing an organic pollutant with the filtration membrane.

In some embodiments, the organic pollutant has a molecular weight of at least 350 g/mol.

In some embodiments, the organic pollutant has a negative charge.

In some embodiments, the method removes greater than 97.5% of an initial amount of organic pollutant.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method of forming the filtration membrane,, according to certain embodiments.

FIG. 1B shows the fabrication of a PPy@PAN/PETP organic solvent nanofiltration (OSN) membrane according to certain embodiments.

FIG. 2 shows reactions and potential chemistry in forming PPy@PAN/PET membrane, according to certain embodiments.

FIG. 3A shows Attenuated Total Reflectance Fourier Transform Infrared spectroscopy (ATR-FTIR) spectra of the HPAN and the PPy@PAN/PETP membrane, according to certain embodiments.

FIG. 3B shows fingerprint regions of spectra of FIG. 3A, according to certain embodiments.

FIG. 4A shows a graph depicting the water contact angle (WCA) of the HPAN and PPy@PAN/PETP membrane, according to certain embodiments.

FIG. 4B & FIG. 4C shows atomic force microscopy (AFM) images of the HPAN membrane, according to certain embodiments.

FIG. 4D & FIG. 4E shows AFM images of the PPy@PAN/PETP membrane according to certain embodiments.

FIG. 5A shows a scanning electron microscopy (SEM) micrograph of the HPAN membrane at 5 μm, according to certain embodiments.

FIG. 5B shows an SEM micrograph of the HPAN membrane at 1 μm, according to certain embodiments.

FIG. 5C shows an SEM micrograph of HPAN membrane at 500 nm, according to certain embodiments.

FIG. 5D shows an SEM micrograph of the PPy@PAN/PETP membrane at 5 μm, according to certain embodiments.

FIG. 5E shows an SEM micrograph of the PPy@PAN/PETP membrane at 1 μm, according to certain embodiments.

FIG. 5F shows an SEM micrograph of the PPy@PAN/PETP membrane at 500 nm, according to certain embodiments.

FIG. 6A shows energy-dispersive X-ray spectroscopy (EDX) image of HPAN, according to certain embodiments.

FIG. 6B shows EDX spectrum of HPAN, according to certain embodiments.

FIG. 6C shows EDX image of PPy@PAN/PETP membrane, according to certain embodiments.

FIG. 6D shows EDX spectrum of PPy@PAN/PETP membrane, according to certain embodiments.

FIG. 6E shows an EDS layered image of HPAN, according to certain embodiments.

FIG. 6F shows elemental mapping of C of HPAN, according to certain embodiments.

FIG. 6G shows the elemental mapping of N of HPAN, according to certain embodiments.

FIG. 6H shows the elemental mapping of O of HPAN, according to certain embodiments.

FIG. 6I shows an EDS layered image of the PPy@PAN/PETP membrane, according to certain embodiments.

FIG. 6J shows the elemental mapping of C of the PPy@PAN/PETP membrane, according to certain embodiments.

FIG. 6K shows the elemental mapping of N of the PPy@PAN/PETP membrane, according to certain embodiments.

FIG. 6L shows the elemental mapping of O of the PPy@PAN/PETP membrane, according to certain embodiments.

FIG. 7 shows a bar graph depicting the effect of increasing transmembrane pressure on the permeate flux of different solvents, according to certain embodiments.

FIG. 8A shows a bar graph depicting the permeate flux of the different dye solutions with PPy@PAN/PETP membrane, according to certain embodiments.

FIG. 8B shows a bar graph depicting rejection performance for the dyes studied at 4 bar using methanol as a solvent for dye solutions, with PPy@PAN/PETP membrane, according to certain embodiments.

FIG. 9A shows a 3D structure congo red (CR), according to certain embodiments.

FIG. 9B shows a 3D structure of erichrome black tea (EBT), according to certain embodiments.

FIG. 9C shows a 3D structure of methylene blue (MB), according to certain embodiments.

FIG. 9D, FIG. 9E and FIG. 9F show absorption spectra of the feeds and permeates collected during OSN experiments, according to certain embodiments.

FIG. 9G, FIG. 9H, FIG. 9I show experimental samples of the different dye solutions and permeates for all the dyes studied at 4 bar using methanol as a solvent for dye solutions, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

The terms “approximately,” “approximate,” “about,” and similar terms generally refer to ranges that include the identified value within a margin of 20%, 10%, or preferably 5%, and any values therebetween.

As used herein, the term “membrane” as used herein refers to a porous structure that is capable of separating components of a homogeneous or heterogeneous fluid. In particular, “pores” in the sense of the present disclosure indicate voids allowing fluid communication between different sides of the structure. When a homogeneous or heterogeneous fluid containing more than one component is passed through the membrane, some components of the fluid can pass through the pores of the membrane into a “permeate stream”, some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Exemplary membranes can be in the form of flat sheets or bundles of hollow fibers. Membranes can also be in various configurations, including but not limited to spiral wound, tubular, hollow fiber, and other configurations identifiable to a skilled person upon reading the present disclosure. Membranes can also be classified according to their pore diameter. Membranes can be neutral or charged, and particle transport can be active or passive.

As used herein, the term ‘hydrogen bonding’ refers to the attractive interaction between a hydrogen atom covalently bonded to a highly electronegative atom (such as nitrogen, oxygen, or fluorine) and another electronegative atom. This interaction is typically weaker than covalent or ionic bonds but stronger than van der Waals forces.

As used herein, the term ‘amines or amine group’ refers to the compounds and functional groups that contain a basic nitrogen atom with a lone pair. Amines are formally derivatives of ammonia (NH₃), where one or more hydrogen atoms have been replaced by a substituent such as an alkyl or aryl group (these may respectively be called alkylamines and arylamines; amines in which both types of substituents are attached to one nitrogen atom may be called alkylarylamines). Amines may include amino acids, biogenic amines, trimethylamine, and aniline. Inorganic derivatives of ammonia are also called amines, such as monochloramine (NClH₂). The term “amines or amine group” should be understood to encompass primary amines, secondary amines, and tertiary amines.

As used herein, the term ‘carboxylate groups’ refers to chemical groups derived from carboxylic acids through the loss of a proton (H⁺) , resulting in the formation of a negatively charged ion or anion known as a carboxylate ion.

### Filtration Membrane

According to a first aspect, the present disclosure is directed to a filtration membrane. In some embodiments, the filtration membrane includes a nonwoven textile. As used herein, the term ‘non-woven textile’ refers to the fabric-like material composed of fibers or filaments that are bonded mechanically, thermally, or chemically rather than woven together through textile processes such as weaving or knitting. In some embodiments, the nonwoven textile includes polyethylene terephthalate (PET). In some embodiments, the polyethylene terephthalate may be substituted by or supplemented with an additional polymer. Examples of additional polymers include, but are not limited to poly(vinylidene) fluoride (PVDF), poly(tetrafluoroethylene) (PTFE), poly(acrylonitrile) (PAN), poly(methyl methacrylate) (PMMA), poly(methacrylic acid) (PMAA), poly(acrylic acid) (PAA), poly(vinyl methyl ketone), polysulfone (PSf), poly(ether sulfone) (PSF), polyacrylonitrile (PAN), polyimide (PI), poly(arylene ether nitrile ketone) (PPENK), and combinations of these. In some embodiments, the PET may be substituted by or supplemented with an additional polymer selected from polybutylene terephthalate (PBT), polytrimethylene terephthalate (PTT), polyethylene naphthalate (PEN), polyethylene isophthalate (PEI), and polyethylene terephthalate glycol-modified (PETG).

In some embodiments, the filtration membrane includes a first layer including a carboxylate-containing polymer disposed on the non-woven textile. In some embodiments, the carboxylate-containing polymer may include a polymer selected from poly(acrylic acid) (PAA), poly (methacrylic acid) (PMAA), polyacrylonitrile (PAN), hydrolyzed polyacrylonitrile, polyacrylamide, poly(acrylamide-co-acrylic acid) (PAAm-co-AA), poly(ethylene-co-maleic acid) (PEMA), poly(vinyl acetate-co-maleic acid) (PVAc-co-MA), and combinations or copolymers thereof. In some embodiments, the carboxylate-containing polymer is hydrolyzed polyacrylonitrile. In some embodiments, the hydrolyzed polyacrylonitrile has a mean molecular weight of 50,000 to 500,000 g/mol, preferably 60,000 to 450,000 g/mol, preferably 75,000 to 400,000 g/mol, preferably 90,000 to 350,000 g/mol, preferably 100,000 to 300,000 g/mol.

In some embodiments, the carboxylate-containing polymer is deposited on the non-woven textile to form a first layer which partially or wholly covers a surface of the non-woven textile. In some embodiments, the first layer is continuous. That is, when the first layer covers an entire surface of the non-woven textile there are not gaps, tears, spaces, or other discontinuities in the first layer, aside from any natural pores present in the first layer. When the first layer covers a part of the surface of the non-woven textile, the portion that is covered is free of gaps, tears, spaces, or other discontinuities in the first layer, aside from any natural pores present in the layer. In some embodiments, the first layer has a uniform thickness. That is, the first layer has relative standard deviation of less than 25%, preferably less than 20%, preferably less than 15%, preferably less than 10%, preferably less than 7.5%, preferably less than 5% of a mean thickness. In some embodiments, the first layer does not have a uniform thickness. In some embodiments, the carboxylate-containing polymers form a continuous layer on the nonwoven textile. In an embodiment, the carboxylate-containing polymer forms a monolayer on the nonwoven textile. In another embodiment, the carboxylate-containing polymer may be present in more than a single layer on the nonwoven textile. For example, the carboxylate-containing polymer is present as two layers, three layers, four layers, five layers, or more.

In some embodiments, the filtration membrane includes a second layer including polypyrrole disposed on the first layer. In some embodiments, the polypyrrole is deposited on the first layer to form a second layer. In some embodiments, the second layer partially or wholly covers a surface of first layer. In some embodiments, the second layer is continuous. That is, when the second layer covers an entire surface of the first layer there are no gaps, tears, spaces, or other discontinuities in the second layer, aside from any natural pores present in the second layer. When the second layer covers a part of the surface of the first layer, the portion that is covered is free of gaps, tears, spaces, or other discontinuities in the second layer, aside from any natural pores present in the second layer. In some embodiments, the second layer has a uniform thickness. That is, the second layer has relative standard deviation of less than 25%, preferably less than 20%, preferably less than 15%, preferably less than 10%, preferably less than 7.5%, preferably less than 5% of a mean thickness. In some embodiments, the second layer does not have a uniform thickness. In some embodiments, the polypyrrole forms a continuous layer on the first layer. In an embodiment, the polypyrrole forms a monolayer on the first layer. In another embodiment, the polypyrrole may be present in more than a single layer on the first layer. For example, the polypyrrole is present as two layers, three layers, four layers, five layers, or more.

In some embodiments, the polypyrrole may be substituted by or supplemented with an additional polymer. In some embodiments, the additional polymer is at least one selected from polythiophene (PTh), poly(3,4-ethylenedioxythiophene) (PEDOT), poly(3-hexylthiophene) (P3HT), and polyacetylene (PA). In some embodiments, the polypyrrole is present as unbranched chains. In some embodiments, the polypyrrole is connected to the first layer by hydrogen bonds between the amine groups present in the polypyrrole and the carboxylate groups present in the carboxylate-containing polymer.

In some embodiments, the second layer includes granules of polypyrrole. In general, the granules can be any shape known to one of ordinary skill in the art. Examples of suitable shapes the granules may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof.

In some embodiments, the granules have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of granules having a different shape. As used herein, the term “non-uniform shape” refers to an average consistent shape that differs by more than 10% of the distribution of granules having a different shape. In one embodiment, the shape is uniform and at least 90% of the granules are spherical or substantially circular, and less than 10% are polygonal.

In some embodiments, the granules have a mean particle size of 100 to 1000 nm, preferably 110 to 900 nm, preferably 125 to 850 nm, preferably 150 to 800 nm, preferably 175 to 750 nm, preferably 200 to 700 nm. In embodiments where the granules are spherical, the particle size may refer to a particle diameter. In embodiments where the granules are polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the granules have an anisotropic shape such as nanorods, the particle size may refer to a length of the nanorod, a width of the nanorod, an average of the length and width of the nanorod. In some embodiments in which the granules have non-spherical shapes, the particle size refers to the diameter of a sphere having an equivalent volume as the particle. In some embodiments in which the granules have non-spherical shapes, the particle size refers to the diameter of a sphere having an equivalent diffusion coefficient as the particle.

In some embodiments, the granules of the present disclosure are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the granules of the present disclosure are monodisperse having a particle size distribution ranging from 80% of the average particle size to 120% of the average particle size, preferably 90-110%, preferably 95-105% of the average particle size. In some embodiments, the granules are not monodisperse.

In some embodiments, the filtration membrane is substantially free of polyaniline. In some embodiments, the filtration membrane is substantially free of graphene oxide.

In some embodiments, the filtration membrane has a water contact angle of 10° to 30°, preferably 11° to 28°, preferably 12° to 27°, preferably 13° to 26°, preferably 14° to 25°, preferably 15° to 24°, preferably 16° to 23°, preferably 17° to 22°, preferably 18° to 21°, preferably 19°. As used herein, the term ‘contact angle’ is the angle between a liquid surface and a solid surface where they meet. More specifically, it is the angle between the surface tangent on the liquid-vapor interface and the tangent on the solid-liquid interface at their intersection. Generally, if the water contact angle is smaller than 90°, the solid surface is considered hydrophilic, and if the water contact angle is larger than 90°, the solid surface is considered hydrophobic.

In some embodiments, the filtration membrane has an average surface roughness Rₐ of 10 to 37.5 nm, preferably 12.5 to 35 nm, preferably 15 to 32.5 nm, preferably 17.5 to 30 nm, preferably 20 to 27.5 nm, preferably 21 to 25 nm, preferably 21.5 to 23 nm, preferably 22.2 nm. In some embodiments, the filtration membrane has a mean squared surface roughness R_{q} of 20 to 50 nm, preferably 22.5 to 45 nm, preferably 25 to 40 nm, preferably 27.5 to 37.5 nm, preferably 30 to 35 nm, preferably 32.5 to 34 nm, preferably 33.3 nm.

In some embodiments, the filtration membrane has a water flux of 75 to 150 L m⁻²h⁻¹, preferably 80 to 125 L m⁻²h⁻¹, preferably 90 to 110 L m⁻²h⁻¹, preferably 100 L m⁻²h⁻¹ at a transmembrane pressure of 20 bar. As used herein, the term ‘water flux’ refers to the water flow rate across a membrane or through a porous medium per unit area. It quantitatively expresses the volume or mass of water passing through a given area per unit of time under specified conditions.

In some embodiments, the filtration membrane has a rejection rate for organic pollutants having a negative charge and a molecular weight of at least 350 g/mol greater than 90%, preferably greater than 92.5%, preferably greater than 95%, preferably greater than 97.5%, preferably greater than 98%, preferably greater than 98.5%, preferably greater than 99%, preferably greater than 99.5%, preferably greater than 99.9%.

In general, the organic pollutant can be any suitable organic pollutant. Examples of types of organic pollutants include, but are not limited to a dye, a phenol, a polycyclic aromatic hydrocarbon, an herbicide, a pesticide, and a persistent organic pollutant. In some embodiments, the organic pollutant is a dye.

A dye is a colored substance that chemically binds to a material it may be intended to color. Generally, a dye is applied to the solution, typically an aqueous solution. Examples of dyes include, but are not limited to: acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIAsH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19,naphthol AS, oil red O, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B.

A phenol is an organic compound with a hydroxyl group (—OH) bonded directly to an aromatic hydrocarbon group. Examples of phenols include, but are not limited to, phenol (the namesake of the group of compounds), bisphenols (including bisphenol A), butylated hydroxytoluene (BHT), 4-nonylphenol, orthophenyl phenol, picric acid, phenolphthalein and its derivatives mentioned above, xylenol, diethylstilbestrol, L-DOPA, propofol, butylated hydroxyanisole, 4-tert-butylcatechol, tert-butylhydroquinone, carvacrol, chloroxyleol, cresol (including M-, O-, and P-cresol), 2,6-di-tert-butylphenol, 2,4-dimethyl-6-tert-butylphenol, 2-ethyl-4,5-dimethylphenol, 4-ethylguaiacol, 3-ethylphenol, 4-ethylphenol, flexirubin, mesitol, 1-nonyl-4-phenol, thymol, 2,4,6-tri-tert-butylphenol, chlorophenol (including 2-, 3-, and 4-chlorophenol), dichlorophenol (including 2,4-and 2,6-dichlorophenol), bromophenol, dibromophenol (including 2,4-dibromophenol), nitrophenol, norstictic acid, oxybenzone, and paracetamol (also known as acetoaminophen).

A polycyclic aromatic hydrocarbon (PAH) is an aromatic hydrocarbon composed of multiple aromatic rings. Examples of polycyclic aromatic hydrocarbons include naphthalene, anthracene, phenanthrene, phenalene, tetracene, chrysene, triphenylene, pyrene, pentacene, benzo[a]pyrene, corannulene, benzo[g,h,i]perylene, coronene, ovalene, benzo[c]fluorine, acenaphthene, acenaphthylene, benz[a]anthracene, benzo[b]fluoranthene, benzo[j]fluoranthene, benzo[k]fluoranthene, benzo[e]pyrene, cyclopenta[c,d]pyrene, dibenz[a,h]anthracene, dibenzo[a,e]pyrene, dibenzo[a,h]pyrene, dibenzo[a,i]pyrene, dibenzo[a,l]pyrene, fluoranthene, fluorine, indeno[1,2,3-c,d]pyrene, 5-methylchrysene, naphthacene, pentaphene, picene, and biphenylene.

An herbicide (also known as “weedkiller”) is a substance that is toxic to plants and may kill, inhibit the growth of, or prevent the germination of plants. Herbicides are typically used to control the growth of or remove unwanted plants from an area of land, particularly in an agricultural context. Examples of herbicides include, but are not limited to, 2,4-D, aminopyralid, chlorsulfuron, clopyralid, dicamba, diuron, glyphosate, hexazinone, imazapic, imazapyr, methsulfuron methyl, picloram, sulfometuron methyl, triclopyr, fenoxaprop, fluazifop, quizalofop, clethodim, sethoxydim, chlorimuron, foramsulfuron, halosulfuron, nicosulfuron, primisulfuron, prosulfuron, rimsulfuron, thofensulfuron, tribenuron, imazamox, imazaquin, flumetsulam, cloransulam, thiencarbazone, fluoxpyr, diflufenzopyr, atrazine, simazine, metribuzin, bromoxynil, bentazon, linuron, glufosinate, clomazone, isoxaflutole, topramezone, mesotrione, tembotrione, acifluorfen, formesafen, lactofen, flumiclorac, flumioxazin, fulfentrazone, carfentrazone, fluthiacet-ethyl, falufenacil, paraquat, ethalfluralin, pendimethalin, trifluralin, butylate, EPTC, ecetochlor, alachlor, metolachlor, dimethenamid, flufenacet, and pyroxasulfone.

A pesticide is a substance meant to prevent, destroy, or control pests including, but not limited to algae, bacteria, fungi, plants, insects, mites, snails, rodents, and viruses. A pesticide intended for use against algae is known as an algicide. Examples of algicides include benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, and tiodonium.

A pesticide intended for use against bacteria is known as a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline.

A pesticide intended for use against fungi is known as a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, teclofthalam, tecnazene, terbinafine, tetraconazole, thiabendazole, thifluzamide, thiphanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, and vinclozolin.

A pesticide intended for use against plants is known as an herbicide, as described above. A pesticide intended for use against insects is known as an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide.

A pesticide intended for use against mites is known as a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, and spirotetramat. A pesticide for use against snails and other mollusks is a molluscicide. Examples of molluscicides are metaldehyde and methiocarb.

A pesticide intended for use against rodents is known as a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, and uragan D2.

A pesticide intended for use against viruses is known as a virucide. Examples of virucides are cyanovirin-N, griffithsin, interferon, NVC-422, scytovirin, urumin, virkon, zonroz, and V-bind viricie.

A persistent organic pollutant is a toxic organic chemical that adversely affects human and environmental health, can be transported by wind and water, and can persist for years, decades, or centuries owing to resistance to environmental degradation by natural chemical, biological, or photolytic processes. Persistent organic pollutants are regulated by the United Nations Environment Programme 2001 Stockholm Convention on Persistent Organic Pollutants. Examples of persistent organic pollutants are Aldrin, chlordane, dieldrin, endrin, heptachlor, hexachlorobenzene, mirex, toxaphene, polychlorinated biphenyl (PCBs), dichlorodiphenyltrichloroethane (DDT), dioxins, polychlorinated dibenzofurans, chlordecone, hexachlorocyclohexane (α- and β-), hexabromodiphenyl ether, lindane, pentachlorobenzene, tetrabromodiphenyl ether, perfluorooctanesulfonic acid, endosulfans, and hexabromocyclododecane.

The filtration membrane of the present disclosure may be advantageous for having an improved liquid flux, an improved selectivity, a reduced fouling, an improved chemical stability, an enhanced mechanical strength, an improved chemical resistance, an advantageous pore size distribution, or any combination of these.

### Method of Forming Filtration Membrane

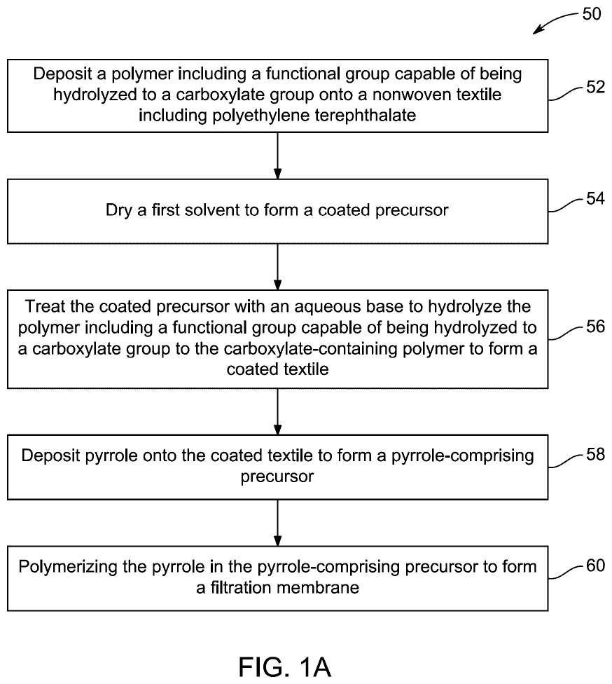

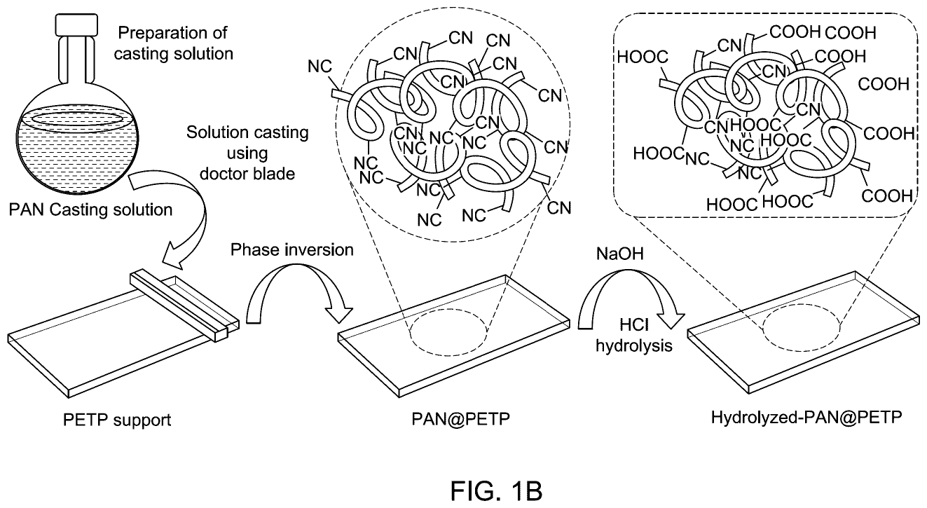

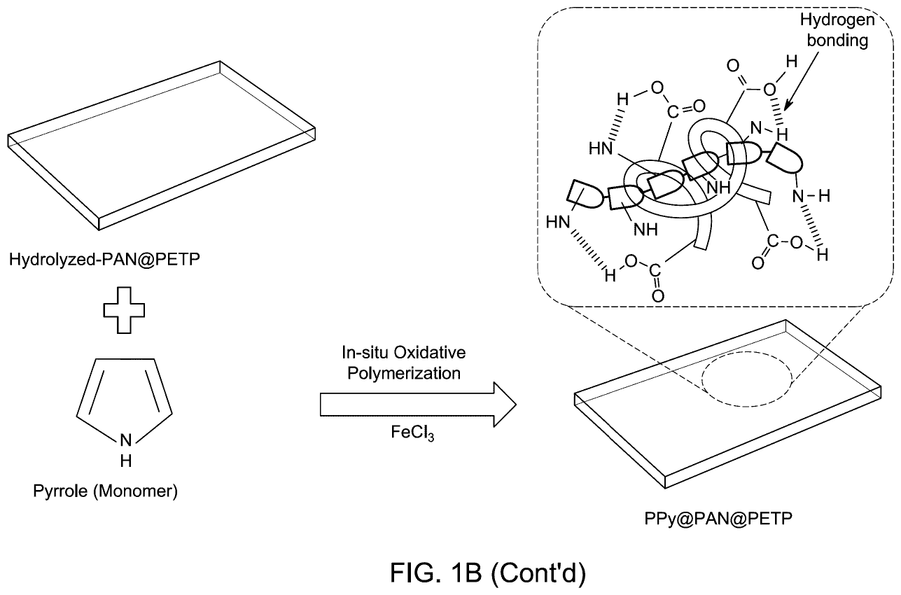

The present disclosure also relates to a method of forming the filtration membrane described above. FIG. 1A illustrates a schematic flow chart of an exemplary method 50 of forming the filtration membrane according to an aspect of the present disclosure. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes depositing a polymer including a functional group that is at least one selected from a carboxylate group and a functional group capable of being hydrolyzed to a carboxylate group onto the nonwoven textile including polyethylene terephthalate. In general, the polymer including a functional group that is at least one selected from a carboxylate group and a functional group capable of being hydrolyzed to a carboxylate group can be as described above. In some embodiments, the including a functional group that is at least one selected from a carboxylate group and a functional group capable of being hydrolyzed to a carboxylate group is polyacrylonitrile.

At step 54, the method 50 includes drying the first solvent to form a coated precursor. In some embodiments, the drying can be performed by using heating appliances such as ovens, microwaves, autoclaves, hot plates, heating mantles and tapes, oil baths, salt baths, sand baths, air baths, hot-tube furnaces, and hot-air guns.

At step 56, the method 50 includes treating the coated precursor with an aqueous base to hydrolyze the polymer. This hydrolysis may convert the functional group capable of being hydrolyzed to a carboxylate group into a carboxylate group to form the carboxylate-containing polymer to form a coated textile. In some embodiments, the aqueous base may be a hydroxide base. Examples of hydroxide bases include, but are not limited to, sodium hydroxide (NaOH), potassium hydroxide (KOH), calcium hydroxide (Ca(OH)₂), ammonium hydroxide (NH₄OH), or a combination thereof. In some embodiments, the coated textile is treated with a neutralization solution, including an acid, before depositing pyrrole. In some embodiments, the acid may be selected from hydrochloric acid, nitric acid, sulfuric acid, hydrobromic acid, hydroiodic acid, and perchloric acid. In some embodiments, the acid is nitric acid.

At step 58, method 50 includes depositing pyrrole onto the coated textile to form a pyrrole-comprising precursor. The pyrrole may be deposited onto the coated textile by methods such as in situ polymerization, dip-coating, electropolymerization, plasma treatment, sequential deposition, or aerosol deposition.

At step 60, the method 50 includes polymerizing the pyrrole in the pyrrole-comprising precursor to form the filtration membrane. In some embodiments, the polymerization may be carried out by treating the pyrrole-comprising precursor with a polymerization solution, including a polymerizing agent/oxidizing agent. The oxidizing agent is intended to denote any oxidizing substance capable of oxidizing pyrrole or a substituted derivative to produce polypyrrole. Pyrrole is a well-known H-bond donor; therefore, it can develop sufficient H-bonding with various functional groups on the support, leading to a stable polypyrrole active layer deposition. Examples of strong oxidants include the cations Fe³⁺, Cu²⁺, and Ce⁴⁺. In general, these oxidizing agents can be provided in any suitable form, such as a salt of the metal ion. In an embodiment, the polymerization agent is FeCl₃. The polymerization of the pyrrole monomer may be adjusted by regulating the concentration of the polymerization agent, temperature, and the polymerization period. In some embodiments, the prepared membrane may be washed with an alcohol, such as methanol or a combination thereof, for further applications.

### Method of Removing an Organic Pollutant

The present disclosure also relates to a method of removing an organic pollutant from a contaminated liquid. The method includes contacting the liquid containing an organic pollutant with the filtration membrane. In some embodiments, the organic pollutant has a molecular weight of at least 350 g/mol, preferably at least 375 g/mol, preferably at least 390 g/mol, preferably at least 400 g/mol, preferably at least 410 g/mol, preferably at least 420 g/mol, preferably at least 425 g/mol, preferably at least 430 g/mol, preferably at least 435 g/mol, preferably at least 440 g/mol, preferably at least 445 g/mol, preferably at least 450 g/mol. In some embodiments, the organic pollutant has a negative charge.

In some embodiments, the liquid is water. In some embodiments, the liquid is an organic solvent. In general, the organic solvent can be any suitable organic solvent. Examples of organic solvents include, but are not limited to, alcohols such as methanol, ethanol, n-propanol, 2-propanol (also known as isopropanol), ethylene glycol, diethylene glycol, and glycerol; hydrocarbons such as pentane, hexane, and heptane; ketones such as acetone and methyl ethyl ketone; esters such as ethyl acetate; amides such as dimethylformamide; ethers such as tetrahydrofuran, diglyme, and diethyl ether; nitriles such as acetonitrile; halogenated organic solvents such as methylene chloride (also known as dichloromethane), carbon tetrachloride, and chloroform; aromatic organic solvents such as benzene and xylene; amines such as trimethylamine and pyridine; and mixtures thereof.

In some embodiments, the activated filtration membrane may be supported on or within a substrate, for example, a column, a disc, a grid, or the like. In some embodiments, the contacting comprises delivering a mixture into a feed side of a chamber comprising the filtration membrane that divides the chamber into the feed side and a permeate side, such that at least a portion of the contaminated liquid permeates the filtration membrane and recovering from the permeate side purified liquid depleted in the organic pollutant compared to the contaminated liquid supplied to the feed side. The chamber used for the present method may be of any shape so long as the filtration membrane can be securely housed and utilized inside the chamber to accomplish the removal of the organic pollutant. The chamber may also include an inlet configured to accept feed material, a first outlet configured to expel a permeate, and an optional second outlet configured to expel a retentate. The chamber can be configured to be pressurized so as to push feed material though the inlet, permeate through the first outlet and optionally, retentate through the second outlet. The chamber can alternatively be configured to operate at reduced pressure as to pull feed material through the inlet, permeate out through the first outlet and optionally, retentate out through the second outlet. The chamber may also include a pump to provide a force for moving liquid from the feed side to the permeate side. In one or more embodiments, a force is provided to deliver the liquid into contact with the activated carbon sorbent.

In some embodiments, the liquid used in the method has a temperature of 1 to 99° C., preferably 20 to 90° C., preferably 21 to 75° C., preferably 25 to 50° C. In some embodiments, the liquid is water having a pH of 2 to 10, preferably 4 to 8, preferably 5.6 to 7.

In some embodiments, the contacting is performed by passing the contaminated liquid through the filtration membrane. In some embodiments, the filtration membrane may be used in series with other currently known adsorption materials to enhance the removal of an organic pollutant from the liquid or to remove a different type of impurity from the liquid that is not an organic pollutant.

In some embodiments, the organic pollutant does not become adsorbed into or onto a surface of the filtration membrane. That is, the filtration membrane serves only to prevent the organic pollutant from passing through the filtration membrane. The filtration membrane does not retain a significant amount of the organic pollutant. In some embodiments, the organic pollutant does become adsorbed into or onto a surface of the filtration membrane. In some embodiments, the adsorption interaction between the organic pollutant and the filtration membrane may be chemisorption, physisorption, or mixtures thereof. In some embodiments, the organic pollutant is adsorbed onto the filtration membrane via a physisorption process, meaning the process is primarily physical and preferably no chemical changes occur on the activated carbon sorbent or organic pollutant.

In some embodiments, the method removes greater than 90%, preferably greater than 92.5%, preferably greater than 95%, preferably greater than 97.5%, preferably greater than 98%, preferably greater than 98.5%, preferably greater than 99%, preferably greater than 99.5%, preferably greater than 99.9% of an initial amount of organic pollutant present in the contaminated liquid. In some embodiments, the purified liquid has least 25% less organic pollutant than that present in the liquid before contact with the filtration membrane, preferably at least 30% less, preferably at least 40% less, preferably at least 50% less, preferably at least 60% less, preferably at least 70% less, preferably at least 80% less, preferably at least 90% less, preferably at least 95% less than that present in the liquid before contact with the filtration membrane. In a preferred embodiment, the purified liquid is substantially free of the organic pollutant, for example, the stream contains less than 10 ppm, preferably less than 1 ppm, preferably less than 100 ppb, preferably less than 1 ppb, preferably less than 0.1 ppb, preferably less than 1 ppt of the organic pollutant. In a most preferred embodiment, the purified liquid is devoid of the organic pollutant.

In some embodiments, the method of the present disclosure further involves cleaning a filtration membrane contaminated with an organic pollutant. In some embodiments, the cleaning involves sonicating a contaminated filtration membrane in an aqueous alcohol solution to form a regenerated filtration membrane. The regenerated filtration membrane may be substantially similar to the filtration membrane described above. The regenerated filtration membrane may be used in the method of removing an organic pollutant described above (reuse). In general, the aqueous alcohol solution may comprise any suitable water miscible alcohol, examples of which include but are not limited to methanol, ethanol, n-propanol, isopropanol, t-butanol, ethylene glycol, propylene glycol, and glycerol. The filtration membrane of the present disclosure may be regenerated and retain greater than 75%, preferably greater than 80%, preferably greater than 85%, preferably greater than 87.5%, preferably greater than 90%, preferably greater than 92.5%, preferably greater than 95%, preferably greater than 97.5%, preferably greater than 99% of an initial organic pollutant removal capacity (e.g., an amount of organic pollutant removed from the contaminated liquid by the filtration membrane) after 2 to 4 regeneration cycles. In some embodiments, the filtration membrane retains the percentage of initial adsorption capacity after up to 10 cycles, preferably up to 15 cycles, preferably up to 25 cycles, preferably up to 50 cycles, preferably up to 100 cycles, preferably up to 150 cycles, preferably up to 200 cycles, preferably up to 250 cycles, preferably up to 300 cycles, preferably up to 350 cycles, preferably up to 400 cycles, preferably up to 500 cycles, preferably up to 625 cycles, preferably up to 750 cycles, preferably up to 1,000 cycles.

The examples below are intended to further illustrate protocols for the preparation, characterization, and use of the filtration membrane and are not intended to limit the scope of the claims.

### EXAMPLES

The following examples are provided solely for illustration and are not to be construed as limitations of the present disclosure, as many variations thereof are possible without departing from the spirit and scope of the present disclosure.

Oxidative polymerization of an aqueous pyrrole (PPy) monomer solution on a hydrolyzed polyacrylonitrile (PAN) support, in the presence of FeCl₃, yields a dense skin layer including a polyaryl network on the PAN support that may have polypyrrole present in pores of the PAN support, e.g., in the form of globule or granules that extend from inside the pores to form an outer surface of the polyaryl network, resulting in a nanofiltration membrane. This nanofiltration membrane may be referred to as a “PPy@PAN/PETP” membrane. The membrane can almost completely reject >99 % of Congo red and Eriochrome black T used as model solutes of different molecular weights. The method of fabricating an OSN membrane is advantageous for being environmentally benign and efficient.

### Example 1. Materials and Methods

Polyacrylonitrile powder (PAN, Molecular weight=150,000 ; (C₃H₃N)ₙ), pyrrole monomer (98%; C₄H₄N), Iron(III) chloride (97%; FeCl₃), sodium hydroxide pellets (≥97%; NaOH) and hydrochloric acid (37%; HCl) were purchased from Sigma (USA). Organic solvents like ethanol, methanol, and iso-porpnaol were purchased from Fisher Scientific.

### Example 2: Fabrication of Ppy@PAN/PETP Nanofiltration Membrane

The PPy@PAN/PETP nanofiltration membrane was prepared by oxidative polymerization of pyrrole using FeCl₃ as an oxidizing agent on the surface of self-fabricated hydrolyzed-PAN/PETP ultrafiltration support, as shown in FIG. 1B. For the fabrication of the PPy@PAN/PETP nanofiltration membrane, PAN/PETP ultrafiltration support was initially prepared by a simple phase inversion process using a self-prepared PAN casting solution on PETP nonwoven fabric. After the fabrication of PAN/PETP ultrafiltration support, it was hydrolyzed by treating it with NaOH followed by HCl solutions. Finally, the PPy active layer was grown on the surface of hydrolyzed-PAN/PETP ultrafiltration support by oxidative polymerization of pyrrole monomer in an aqueous medium using FeCl₃ as an oxidizing agent. For this, firstly, the hydrolyzed-PAN/PETP ultrafiltration support was dipped in an aqueous solution of pyrrole monomer to adsorb the pyrrole monomer on the surface of hydrolyzed-PAN/PETP ultrafiltration support. After the adsorption of pyrrole monomer on hydrolyzed-PAN/PETP support, FeCl₃ solution was added to the reaction vessel. This caused the pyrrole to oxidatively polymerize, resulting in the formation of a PPy-dense active layer on the hydrolyzed-PAN/PETP support. The PPy-decorated hydrolyzed-PAN/PETP (PPy@PAN/PETP) nanofiltration membrane was completely washed with DI water and methanol after oxidative polymerization in FeCl₃. The resultant PPy@PAN/PETP nanofiltration membrane was utilized for organic solvent nanofiltration. Various steps involved in the fabrication of the PPy@PAN/PETP nanofiltration membrane are shown in FIG. 1B.

### Example 3: Characterization

The formation of the PPy@PAN/PETP nanofiltration membrane was confirmed using a Fourier transform infrared spectrometer (ATR-FTIR, Nicolet iS-50, Thermo Fisher Scientific), Goniometry (Drop-shape analyzer, KRUSS, DSA25), atomic force microscopy (AFM, Agilent-550), and scanning electron microscopy coupled with Energy dispersive X-ray spectroscopy (SEM/EDX, Coxem EM-30AX SEM).

### Example 4: Infrared Spectroscopy

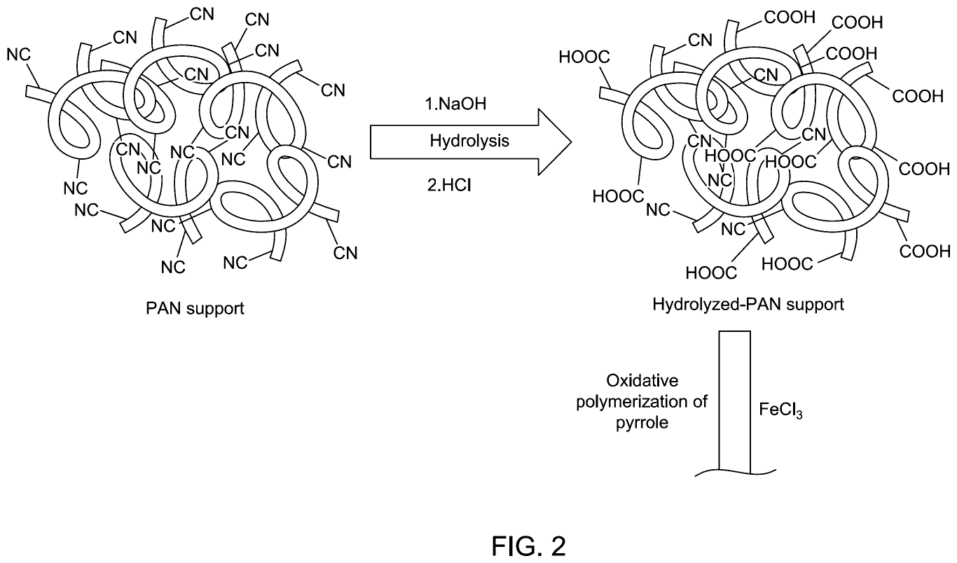

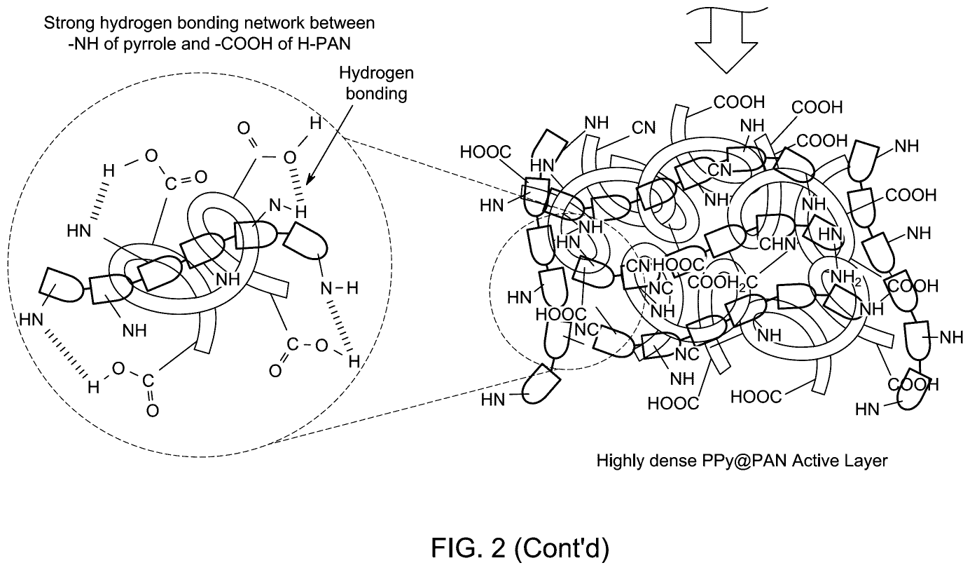

This fabrication of the current membrane is based on strong hydrogen bonding between the PAN and PPy due to several hydrogen bond donor and recipient groups present in the structure of these polymers. This allows the active layer including polypyrrole to be stably and firmly attached to the ultrafiltration PAN support. The nitrile groups (CN) present in the structure of the PAN framework were hydrolyzed, leading to carboxylic groups (—COOH) which can easily link with the NH groups present in the PPy network. Due to the abundance of carboxyl groups in the structure of ultrafiltration PAN support, the attachment of PPy became highly stable. A depiction of the hydrogen bonding interaction is provided in FIG. 2. The resultant membrane was found to be quite dense and uniform when observed under different membrane characterization techniques.

To confirm the presence of various functionalities inside the structure of the different layers of the fabricated membrane, ATR-FTIR spectra of the hydrolyzed PAN and the PPy@PAN/PET membrane were recorded. The hydrolyzed PAN showed all the characteristic peaks based on the structure of the hydrolyzed PAN support. A broad absorption band in the region of 3600 cm⁻¹ to 3200 cm⁻¹ was observed in the case of hydrolyzed PAN, which is attributed to the presence of several carboxylic functions (—COOH) generated during hydrolysis of nitrile (CN) groups in PAN. In the region of 2900 cm⁻¹, the shoulder is at 2800 cm⁻¹, which is due to the aliphatic backbone of PAN. A sharp peak was observed in the region of 2200 cm⁻¹ due to residual CN groups in the hydrolyzed PAN support. A peak in the region of 1650 cm⁻¹ was observed, which is due to the presence of the carbonyl (>C═O) functional group of the carboxylic group in PAN support. Hence, FTIR supported the generation of carboxylate functional groups in the structure of hydrolyzed PAN support.

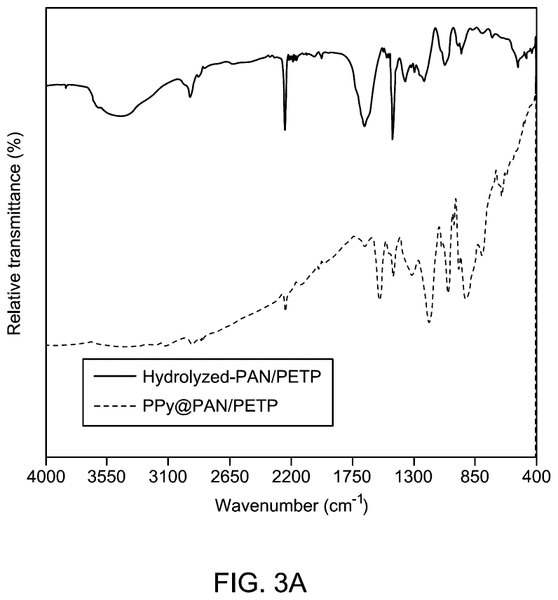

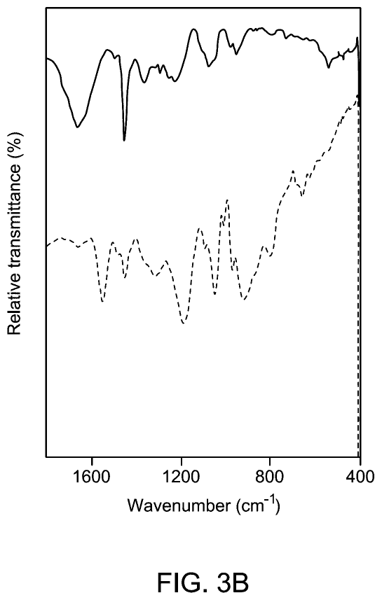

In the case of decoration of PPy on the hydrolyzed PAN support, there were certain variations in the FTIR spectrum of the fabricated PPy@PAN/PET membrane compared to pristine hydrolyzed PAN support. For example, the band located in the region of 3600 cm⁻¹ to 3200 cm⁻¹ reduced in its intensity while very short peaks appeared in the region of 3000 cm⁻¹, 2900 cm⁻¹, and 2800 cm⁻¹ (FIGS. 3A-3B). Similarly, the intensity of the peak due to the cyano (CN) group was also reduced to a greater extent. The reduction in the intensity of the characteristic peaks of hydrolyzed PAN confirms that a layer of PPy covers the hydrolyzed PAN considerably. So, due to the oxidative polymerization of monomers on the surface of hydrolyzed PAN support, the functional groups of HPAN are masked to a greater extent. This is confirmatory evidence for the growth of the PPy active layer on the hydrolyzed PAN support.

The PPy showed peaks at 1546 cm⁻¹ and 1460 cm⁻¹ which are due to C═C bond stretching vibrations of the pyrrole ring [S. Ahmad, I. Khan, A. Husain, A. Khan and A. M. Asiri, Polymers (Basel)., 2020, 12, 1-14, incorporated herein by reference it its entirety]. Similarly, the other peaks of PPy, such as 1306 cm⁻¹, 1186 cm⁻¹, and 1042 cm⁻¹, are due to C═N bond bending and C—N bond stretching and ═C—H bending vibrations, respectively. The other two peaks at 788 cm⁻¹ and 678 cm⁻¹ are due to the C—H out-of-plane vibration mode of the PPy ring. However, the peaks due to PPy on the hydrolyzed PAN support in PPy at PPy@PAN/PET membrane show a slight shift towards a higher wavenumber. The characteristic peak of PPy at 1546 cm⁻¹ is shifted to 1564 cm⁻¹. The other peaks of pristine PPy reported in the literature were also shifted to higher wavenumbers such as 1465 cm⁻¹, 1315 cm⁻¹, 1205 cm⁻¹, 1040 cm⁻¹, 930 cm⁻¹ and 791 cm⁻¹ (FIGS. 3A-3B). This shift in the peaks after deposition of PPy on hydrolyzed PAN support confirmed that there was a strong interaction between the PPy chains and hydrolyzed PAN happening at the molecular level, which can be attributed to hydrogen bonding based on the structures of the polymers. Hence, the hydrogen bonding between the PPy active layer and hydrolyzed PAN is an aspect of the present disclosure and is responsible for the stable decoration of the PPy active layer on the hydrolyzed PAN, resulting in an OSN membrane.

### Example 5: Suface Hydrophilicity

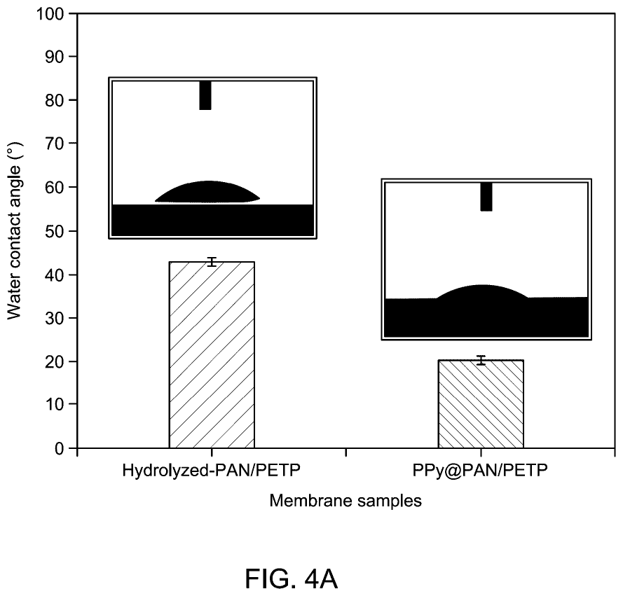

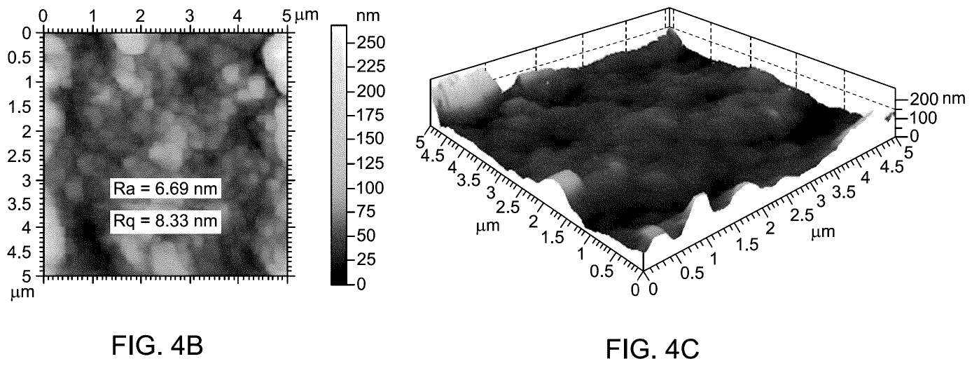

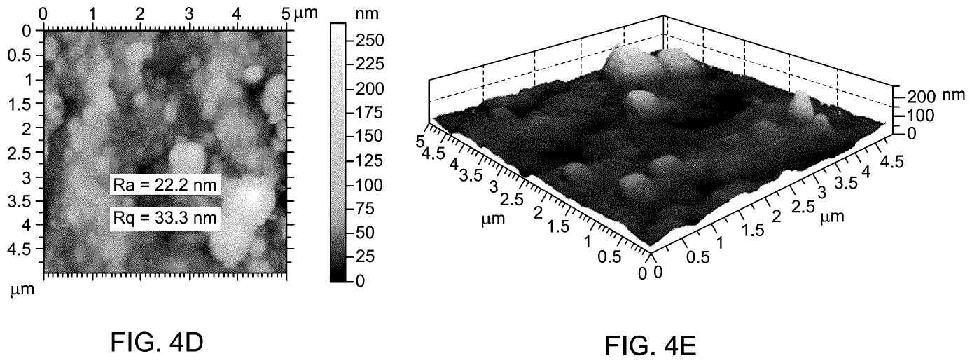

Among the different surface features of the fabricated membrane, surface hydrophilicity is of utmost importance in understanding the performance of the resultant membrane. In the present disclosure, a water droplet was contacted with a completely dried membrane sample. Based on the surface hydrophilicity of the membrane sample under consideration, the water droplet spread on the surface of the membrane sample. In the case of pristine hydrolyzed PAN support, the water contact angle (WCA) was found to be 40°. However, WCA showed a further decrease in the PPy@PAN/PETP membrane with a value of 19° (FIG. 4A). WCA depends on several factors, among which membrane surface chemistry and surface roughness are of prime importance. The hydrophilic nature of hydrolyzed PAN is due to the presence of numerous carboxylic groups in the structure of the hydrolyzed PAN because carboxyl groups have a strong attraction for water molecules, leading to a reduced WCA resulting in increased hydrophilicity of the PPy@PAN/PETP membrane. A further decrease in WCA of the PPy@PAN/PETP membrane is attributed not only to the chemistry of the membrane but also to the increased surface roughness of the PPy@PAN/PETP. It has been observed that an increase in the surface roughness of a hydrophilic surface causes a decrease in WCA, making it considerably hydrophilic, as observed in the case of the PPy@PAN/PETP membrane.

### Example 6: Atomic Force Microscopy

To explore the surface features of the fabricated PPy@PAN/PETP membrane, the atomic force microscopy (AFM) of pristine hydrolyzed PAN and PPy@PAN/PETP membrane was performed as shown in FIGS. 4B to 4E. When the surface roughness of the pristine hydrolyzed PAN surface was studied, an average surface roughness Rₐ=6.69 nm and mean squared surface roughness R_{q}=8.33 nm were found (FIGS. 4B and 4C). The surface topology of the pristine membrane showed a relatively uniform and smooth surface. However, after the oxidative polymerization of the pyrrole monomer resulting in the growth of the PPy active layer on the hydrolyzed PAN support, the Rₐ of the PPy@PAN/PETP membrane was increased to a value of Rₐ=22.2 nm with R_{q}=33.3 nm (FIGS. 4D and 4E). This increase in the surface roughness of the PPy@PAN/PETP membrane was due to the growth of the PPy polymeric network on the hydrolyzed PAN support.

The surface topology exhibited the presence of several uniformly distributed polymeric globules on the membrane surface. This ridge and valley configuration may be advantageous for efficiently separating solutes from the permeate. Therefore, the investigation of surface roughness and topology of the membrane confirms the establishment of a dense PPy active layer required for organic solvent nanofiltration.

### Example 7: Scanning Electron Microscopy

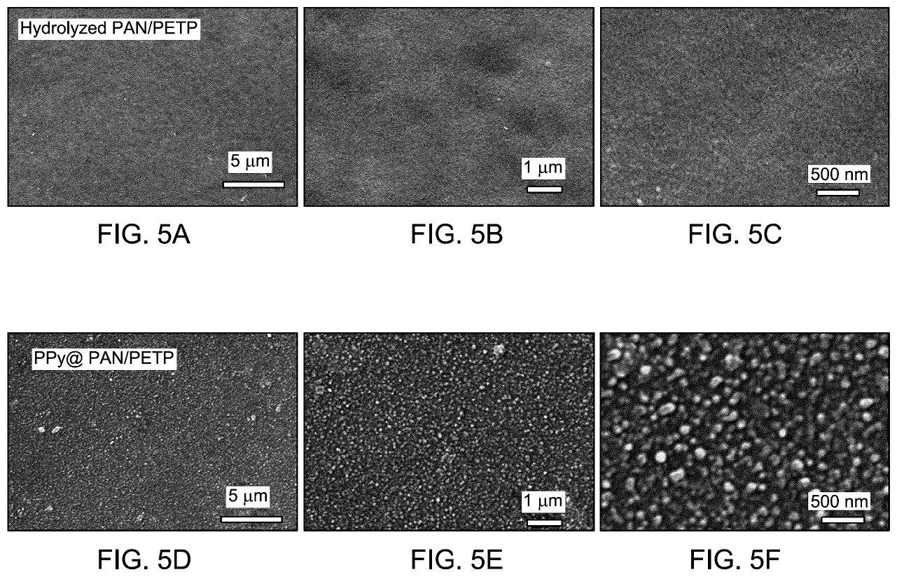

The SEM micrographs of both the pristine hydrolyzed PAN support and fabricated PPy@PAN/PETP membrane are shown in FIGS. 5A-5F. In the pristine hydrolyzed PAN support (FIGS. 5A to 5C), the surface appeared to be quite smooth, as confirmed through AFM, with a highly porous nature with pores decorated throughout the membrane. Pores are generated due to wet phase inversion, during which demixing of the solvent happens, leading to rapid precipitation of PAN polymer. After the growth of the PPy network on the surface of the hydrolyzed PAN, its surface was considerably altered. The surface of the fabricated PPy@PAN/PETP membrane appeared highly granular, and the granules covered the surface of the hydrolyzed support (FIGS. 5D to 5F). When magnified to high resolution, these granules appeared in the form of uniformly sized and equally distributed globules of polypyrrole generated during oxidative polymerization of pyrrole. An investigation of the surface morphology of the pristine and fabricated PPy@PAN/PETP membrane revealed that a considerable active layer of PPy was generated during oxidative polymerization on the hydrolyzed PAN support. The globular appearance of the membrane surface in the form of ridge and valley confirmation may be advantageous for membrane separations.

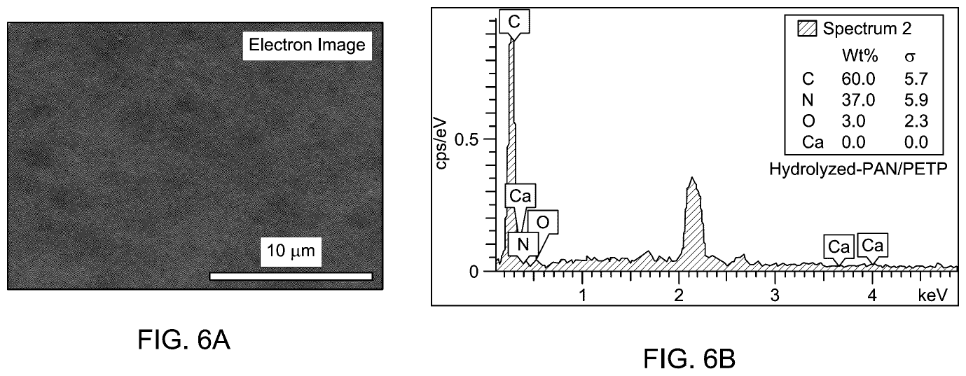

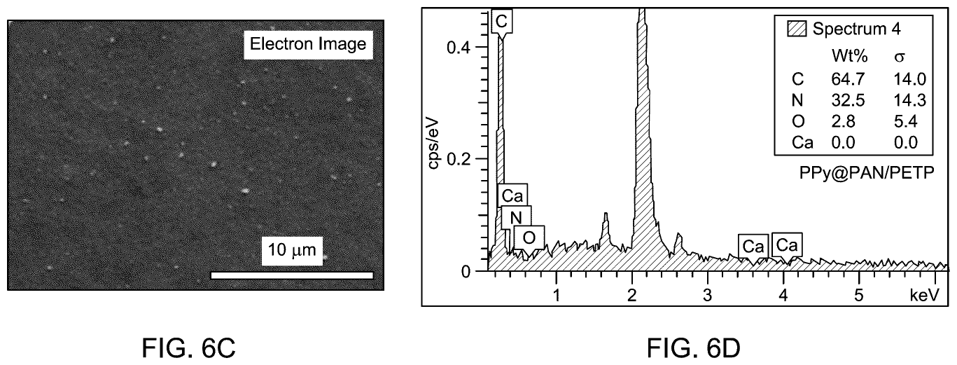

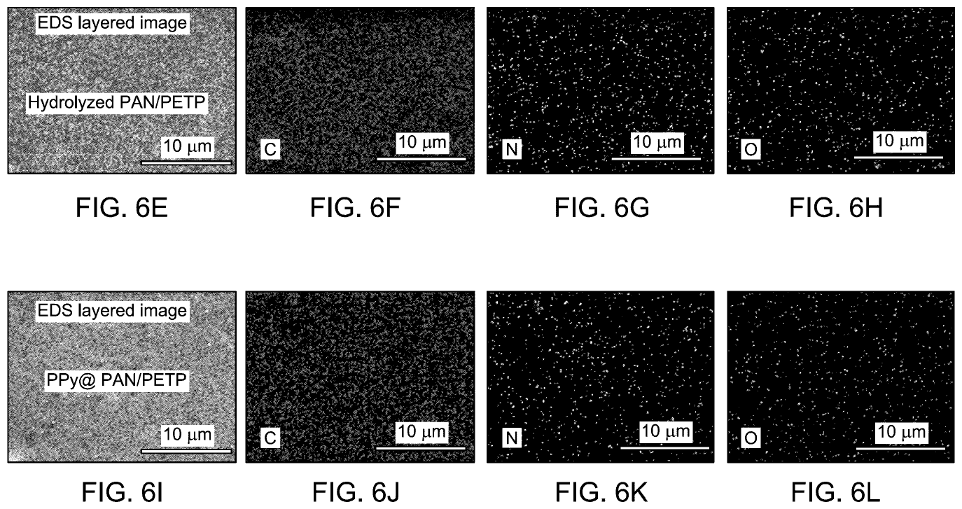

To determine the percentage composition of different elements and their respective distribution in the membrane area, EDX analysis and elemental mapping analysis were carried out. The EDX analysis (FIG. 6A) and mapping analysis (FIGS. 6D to 6H) of the hydrolyzed PAN exhibited the presence of all of the elements, including carbon (C), oxygen (O), and nitrogen (N), which is due to the presence of C containing backbone, O containing —COOH and N containing CN group in the structure of the hydrolyzed PAN. Based on the chemical structure of the polymer under consideration, the carbon (C), nitrogen (N), and oxygen (O) were observed to be present in the PPy@PAN/PETP membrane (FIG. 6C). The origin of C and N can be attributed to the presence of pyrrole moiety because the pyrrole ring is composed of both C and N. Similarly, another source of C and N is the hydrolyzed PAN because of the presence of carbon backbone and N containing unhydrolyzed CN groups in the structure of the hydrolyzed PAN polymer. The presence of oxygen in the EDX analysis is due to carboxylic (—COOH) functional groups in the hydrolyzed support. Also, some O originates from the PETP nonwoven fabric support. Hence, the elemental composition is wholly consistent with the existence of all three membrane layers.

The mapping analysis (FIGS. 6I to 6L) of the PPy@PAN/PETP membrane revealed the existence of all the elements in the membrane that were identified by the EDX analysis, and all of the elements were found to be distributed in the entire region of the membrane uniformly. However, the concentration of each element in the PPy@PAN/PETP membrane is reflected by the concentration of colored dots in the mapping analysis (FIGS. 6I to 6L). For example, carbon is highly abundant in all membranes, so the density of the mapping dots is very high, while nitrogen is less abundant. Hence, the relative density of the mapping dots is less in the mapping.

### Example 8: Filtration

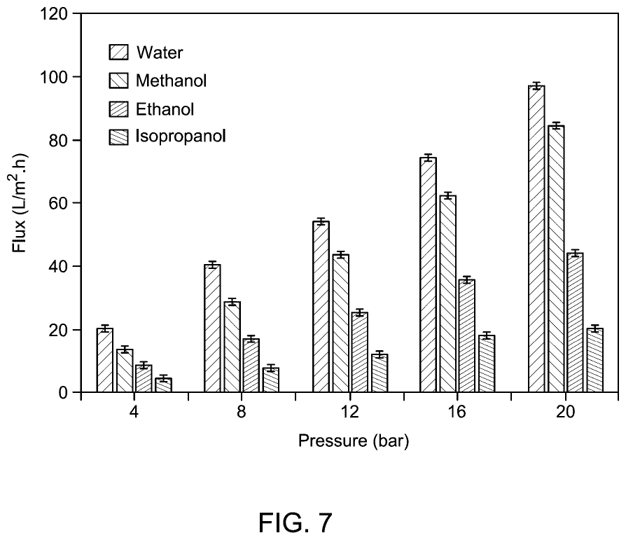

After compacting the membrane with DI water, the effect of increasing transmembrane pressure on the permeate flux was studied, as shown in FIG. 7. Different types of polar organic solvents, such as methanol, ethanol, and isopropanol along with water, were used as feed during filtration experiments. As anticipated, the permit flux increased linearly with increasing transmembrane pressure, reflecting the integrity and stable structure of the thin film composite PPy@PAN/PETP membrane under filtration conditions. Among the different polar solvents studied, water showed the highest flux, reaching a value of 100 L m⁻²h⁻¹ at a transmembrane pressure of 20 bar. Conversely, isopropanol showed the lowest permeate flux, measured as 20 L m⁻²h⁻¹ at 20 bar. The permeation of a solvent through the membrane depends on several factors. The variation in permeate flux can be attributed to two key factors: the relative molecular size of the polar solvents being considered and the solvent's viscosity under study. Since size exclusion is a well-known phenomenon that explains the transport of molecules across the membrane, it appears that the permeate flux of different solvents is also dependent on the size exclusion principle. Moving from the smaller water molecule to the larger isopropanol molecule revealed a decline in the permeate flux. Similarly, the permit flux decreases with an increase in the viscosity of the solvent from water to isopropanol.

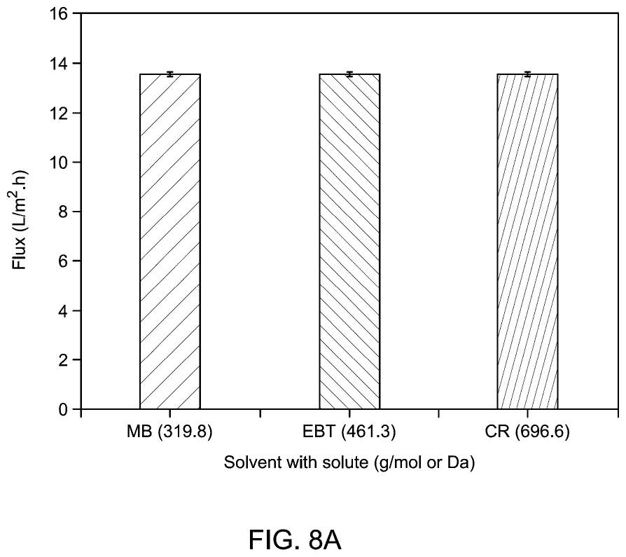

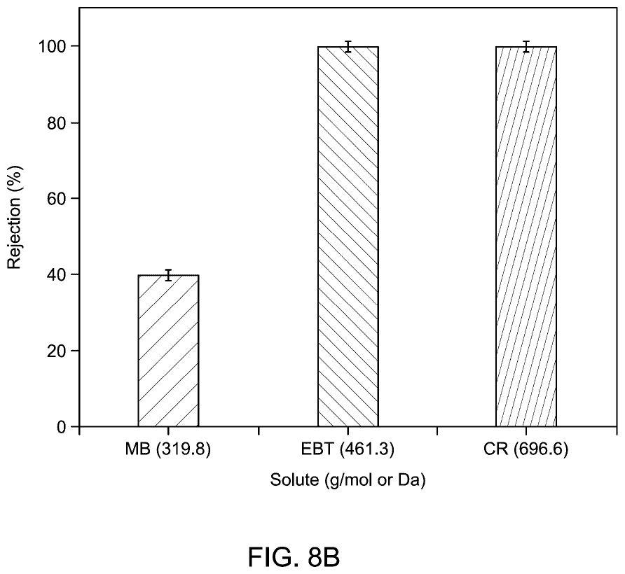

The rejection of differently-sized solute molecules is shown in FIGS. 8A-8B. Three different dyes, namely Congo red (CR), Eriochrome black T (EBT), and methylene blue (MB), were used as solute molecules during OSN performance analysis of the PPy@PAN/PETP membrane. 10 ppm solution of each dye was prepared in methanol as a solvent for OSN experiments. The permeate flux value of the different dye solutions at a constant transmembrane pressure of 4 bar was also studied. The flux did not show any dependence on the dye under study during the OSN performance, as the value of the permeate flux remained nearly constant at about 13 L m⁻²h⁻¹ for all three dyes studied (FIG. 8A). However, when rejection performance of the PPy@PAN/PETP membrane for dyes dissolved in methanol was studied, the PPy@PAN/PETP membrane was able to completely reject CR and EBT whereas MB was rejected to nearly 48% (FIG. 8B). The rejection of the dyes molecules also follows the size exclusion principle because MB being the smallest dye in the present disclosure was not completely rejected while other dyes with a bigger molecular size were almost completely rejected. In addition to the size of the dye molecules used in the present disclosure, the charge on the dye molecules was also quite important. CR and EBT are negatively charged dye molecules, whereas MB is a positively charged dye. The rejection of negatively charged dyes is considerably higher than the positively charged ones. This observation may be due to the surface of the membrane having a negative charge responsible for the rejection of the negatively charged dye molecules. If the membrane surface has an opposite charge to the positively charged dye molecules and an attraction for the positively charged dyes may allow them to permeate through the membrane.

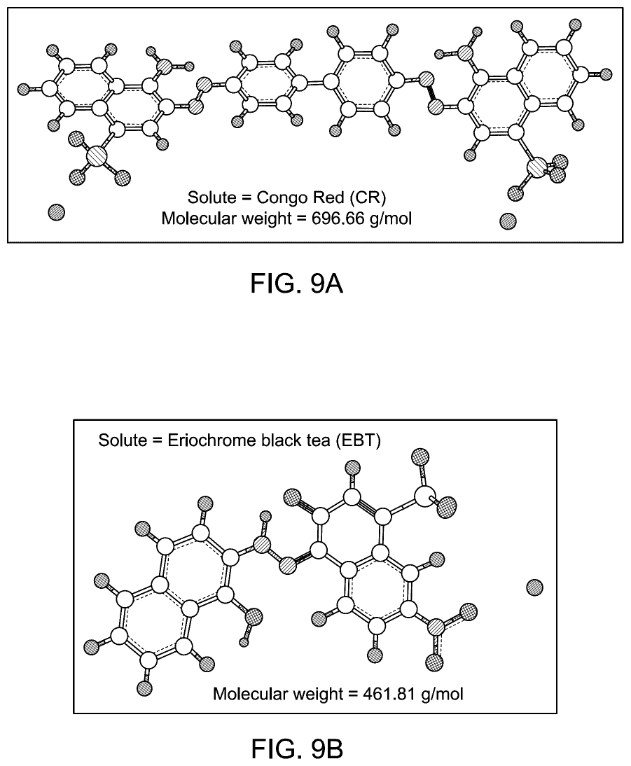

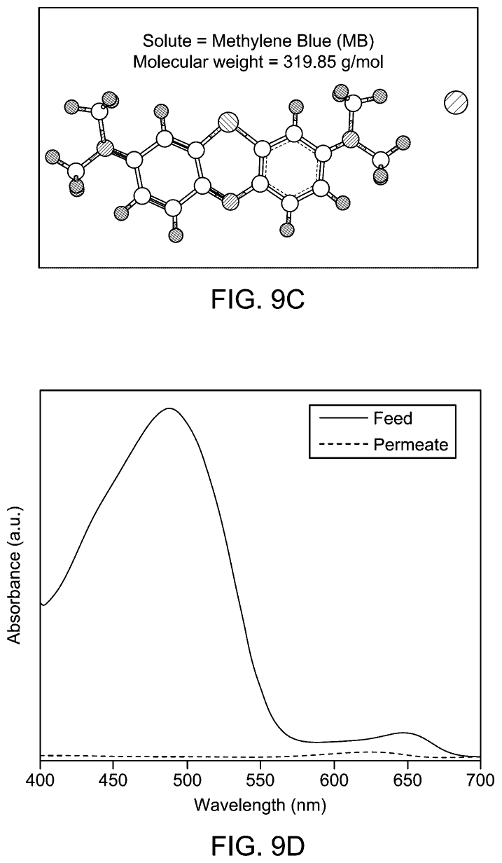

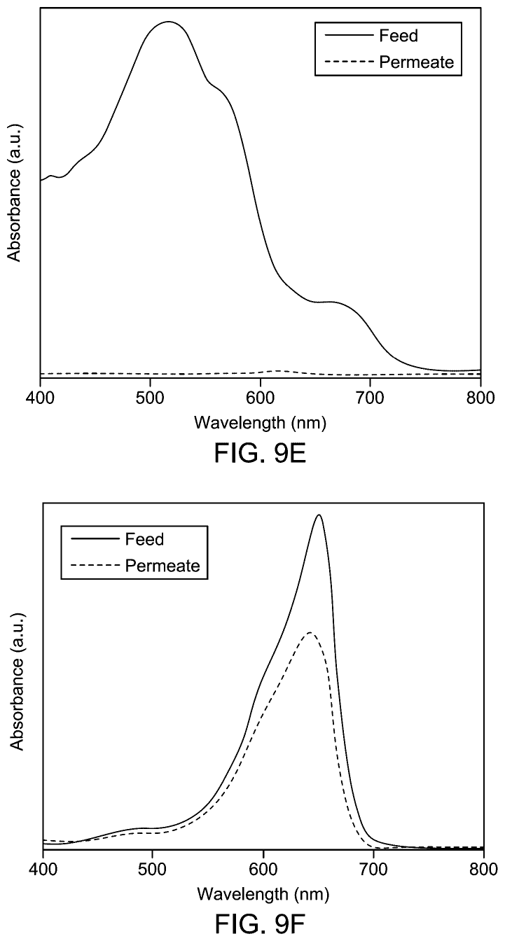

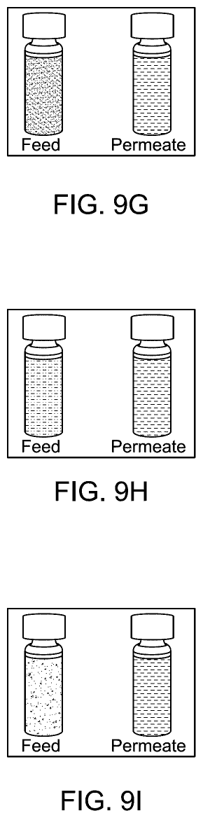

FIGS. 9A to 9C show the graphical representation of the structures of the dyes used in this study as a model as solutes during OSN experiments. The three-dimensional structures of the different types of dyes also vary in their special arrangement, which may contribute towards the rejection of a dye during OSN. For example, the structure of MB is linear, which may permit MB to more readily pass through the PPy@PAN/PETP membrane. The absorption spectrum of feeds and permeates collected during the OSN filtration experiments are also given in the FIGS. 9E to 9F. The absorption spectra of CR and EBT revealed that the absorption maxima of both CR and EBT after passing through the PPy@PAN/PETP membrane completely disappeared, and the absorption spectra of permeates appeared as a flat line, which means that both of the dyes were completely rejected during the OSN experiments. In the case of MB, the absorption spectrum of the permeate did not show any appreciable decrease in absorption, which confirms the low rejection of MB during filtration experiments. The confirmatory photographic images of the feeds and permeates of different dyes used during the OSN study are also given in FIGS. 9G to 9I. FIG. 9G and FIG. 9I shows the field and permeates of CR and EBT, respectively, where the permeates are completely free of any coloration, which indicates that the PPy@PAN/PETP membrane has completely removed these dyes. However, in the case of MB, there is still coloration in the permeate. Hence, the PPy@PAN/PETP membrane could reject dyes with a molecular weight of 450 g mol⁻¹.

The current approach of fabricating a thin film composite membrane may be advantageous for being highly facile, green, and a simple single-step process. Generally, interfacial polymerization, which can use neurotoxic chemicals such as n-hexane, is an expensive and highly sensitive procedure, particularly for the high level of control of the process during filtration membrane preparation. The current approach may be advantageous for fabricating filtration membranes where the thickness of the active layer can be controlled by controlling the rate and degree of polymerization.

Numerous modifications and variations of the present disclosure are possible in light of the above teachings. It is therefore to be understood that within the scope of the appended claims, the invention may be practiced otherwise than as specifically described herein.

1. A filtration membrane, comprising
a nonwoven textile comprising polyethylene terephthalate;
a first layer comprising a carboxylate-containing polymer disposed on the nonwoven textile;
a second layer comprising polypyrrole oxidatively polymerized on the first layer,
wherein the polypyrrole is connected to the first layer by hydrogen bonds between amine groups present in the polypyrrole and carboxylate groups present in the carboxylate-containing polymer.

2. The filtration membrane of claim 1, wherein the polypyrrole is present as unbranched chains.

3. The filtration membrane of claim 1, wherein the second layer comprises granules of polypyrrole.

4. The filtration membrane of claim 3, wherein the granules of polypyrrole have a mean particle size of 100 to 1000 nm.

5. The filtration membrane of claim 1, wherein the carboxylate-containing polymer is hydrolyzed polyacrylonitrile.

6. The filtration membrane of claim 5, wherein the hydrolyzed polyacrylonitrile has a mean molecular weight of 50,000 to 500,000 g/mol.

7. The filtration membrane of claim 1, having a water contact angle of 10 to 30°.

8. The filtration membrane of claim 1, having an average surface roughness Rₐ of 10 to 37.5 nm and a mean squared surface roughness R_{q} of 20 to 50 nm.

9. The filtration membrane of claim 1, having a water flux of 75 to 150 Lm⁻²h⁻¹ at a transmembrane pressure of 20 bar.

10. The filtration membrane of claim 1, having a rejection rate for organic pollutants having a negative charge and a molecular weight of at least 350 g/mol of greater than 97.5%.

11. The filtration membrane of claim 1, which is substantially free of graphene oxide.

12. The filtration membrane of claim 1, which is substantially free of polyaniline.

13. A method of forming the filtration membrane of claim 1, the method comprising
depositing a polymer comprising a functional group capable of being hydrolyzed to a carboxylate group onto the nonwoven textile comprising polyethylene terephthalate;
drying the first solvent to form a coated precursor;
treating the coated precursor with an aqueous base to hydrolyze the polymer comprising a functional group capable of being hydrolyzed to a carboxylate group to the carboxylate-containing polymer to form a coated textile;
depositing pyrrole onto the coated textile to form a pyrrole-comprising precursor; and
polymerizing the pyrrole in the pyrrole-comprising precursor to form the filtration membrane.

14. The method of claim 13, wherein the polymer comprising a functional group capable of being hydrolyzed to a carboxylate group is polyacrylonitrile having a molecular weight of 50,000 to 500,000 g/mol.

15. The method of claim 13, wherein the polymerizing is performed by treating the pyrrole-comprising precursor with a polymerization solution comprising iron chloride.

16. The method of claim 13, further comprising treating the coated textile with a neutralization solution comprising an acid prior to depositing pyrrole.

17. A method of removing an organic pollutant from water comprising contacting water containing an organic pollutant with the filtration membrane of claim 1.

18. The method of claim 17, wherein the organic pollutant has a molecular weight of at least 350 g/mol.

19. The method of claim 17, wherein the organic pollutant has a negative charge.

20. The method of claim 17, wherein the method removes greater than 97.5% of an initial amount of organic pollutant.
